(19) United States
(12) Patent Application Publication
(10) Pub. No.: US 2026/0133065 A1
(43) Pub. Date: May 14, 2026

(54) CONTAINER LEVEL DETECTOR

(71) Applicant: Iveda Solutions, Inc., Mesa, AZ (US)

(72) Inventors: DAVID HIEU LY, Chandler, AZ (US); SZU-HAN CHEN, Taipei (TW); YUN-SHENG LIU, Hsinchu City (TW)

(21) Appl. No.: 18/942,179

(22) Filed: Nov. 8, 2024

(51) Int. Cl. G01F 23/74; G01F 23/00; G01F 23/80

(52) U.S. Cl. CPC G01F 23/74; G01F 23/0007; G01F 23/804

(57) ABSTRACT

Level is detected of contents of a container or drum. Systems may wirelessly report when contents of the container are nearly depleted. Components include a plug, a sensor, a structural member, a terminal connector in the plug, and internal and external cables. The plug may screw into a vent hole in the container and a signal connector on the external cable connects to the terminal connector. The connectors may be configured or have magnets to prevent reverse connection. Various embodiments have a second sensor, a wireless gateway, GPS location data, cloud data processing, or a recess to receive a tool to rotate the plug and remove the system from the container. The structural member may bend to maintain verticality.

### FIELD THE INVENTION

Various embodiments of this invention relate to apparatuses, processes, and systems for detecting a level of contents within a container (e.g., a drum), for example, using at least one sensor. Particular embodiments, for instance, include a plug that mounts in a hole in the container, at least one sensor, a structural member extending at least from the plug to the sensor, and at least one internal cable.

### BACKGROUND OF THE INVENTION

Various contents, including liquids, have been transported & stored within a variety of different containers. Further, contents have been removed from containers as needed, and additional contents have been obtained (e.g., purchased) as needed, for instance, when the contents on hand have been partially or fully used or consumed. Traditional liquid storage container level monitoring has relied on manual measurement or regular inspections, which have been inefficient and prone to errors. Therefore, there is a need for a more intelligent and automated liquid level monitoring system that can accurately monitor liquid levels in real time and remotely access monitoring data. Needs and potential for benefit exist, for example, for systems, methods, and devices for determining or detecting when contents of a container have been partially or fully consumed or are running low so that additional contents can be ordered, for example, in time to avoid a shortage.

Further, drums or barrels have been used to transport and store various contents or cargo including oil. These cylindrical shipping containers can be made of steel, paperboard, or plastic, as examples, and can be used for the transportation and storage of liquids or granular solids, for instance. With some drums, the top head is removable and is attached with a closing ring. Other drums have a non-removable top head, for example, that is permanently attached by the manufacturer. Some such drums have one or two threaded access holes, for instance, that are plugged with threaded bungs after filling. Further, closed-head steel barrels and drums used for shipment of chemicals and petroleum products have been used that have a standardized bunghole arrangement. For example, some drums have one 51-mm (2 inch) (DN50) NPT hole and one 19-mm (¾ inch) (DN20) NPT threaded hole. These two holes may be located on opposite sides of the top head, for example. The smaller hole may be a vent hole. Industrial standards for drums include ISO: 15750-1:2002, 15750-2:2002, and 15750-3:2022.

Various apparatuses have been used or contemplated that detect a level of contents within a container. Transparent tubing has been used, for example. Further, sensors have been used to detect the level of contents of a container. Even further, Hall effect sensors and floats have been used, as well as various systems for processing and communicating information concerning the level of contents within containers. Room for improvement exists, however, in level detection of contents of containers including drums. For example, potential for benefit exists in the way content levels are obtained, handled, and communicated, and in the systems and devices used to do so. Potential for benefit exists, for instance, for apparatuses, processes, and systems that are more versatile, less expensive, more reliable, communicate more effectively, or a combination thereof, as examples. Further, room for improvement exists in devices that communicate content levels, for example, from sensors to systems that utilize content level information. Potential for benefit exists in these and other areas that may be apparent to a person of skill in the art who has studied this document.

### SUMMARY OF PARTICULAR EMBODIMENTS OF THE INVENTION

Various embodiments detect a level of the contents of a container. Further, various embodiments form, or are part of, an apparatus that detects a level of contents within a container. For example, a number of embodiments provide an intelligent and convenient circular iron drum liquid level sensor detection system, which can be widely used in various liquid storage scenarios. Further, various embodiments have a high market value and application prospects. Still further, some embodiments provide a connector designed to mount in a breathable opening of a metal drum. In various embodiments, the connector and plug is used to connect a (e.g., liquid) level sensor and transmit a level signal to a wireless gateway outside the drum. This connector may be easy to install and remove, for example, without affecting the sealing performance of the drum. Different embodiments include different combinations of specific components or elements. For instance, various embodiments include a plug (e.g., that mounts in a hole in the container) one or more level sensors, a structural member (e.g., extending from the plug at least to the sensor), and at least one internal cable (e.g., extending from the sensor to the plug).

A number of embodiments are or include, for example, an apparatus that detects a level of contents within a container. Further, some embodiments use one or more sensors to detect the level of contents of a container. Even further, certain embodiments include various systems for processing and communicating information concerning the level of contents within containers. Still further, various embodiments include improvements in level detection of contents of containers, for example, including drums. Further still, particular embodiments include improvements in the way content levels are obtained, handled, or communicated, or in the systems and devices used to do so. Even further still, certain embodiments of apparatuses, processes, and systems are more versatile, less expensive, more reliable, communicate more effectively, or a combination thereof, as examples, in comparison to previous technology. Moreover, various embodiments include improvements in devices that communicate content levels, for example, from sensors to systems that utilize content level information. Improvements exist in these and other areas that may be apparent to a person of skill in the art who has studied this document.

Specific embodiments are or include, for example, apparatuses for detecting a level of contents within a container. Such an apparatus may include, for example, a plug, a first sensor, a structural member, a terminal connector, a first internal cable, and an external cable. The plug may be configured to mount in a hole in the container, for instance, and the first sensor may detect a first level of the contents in the container. Further, the structural member may extend (e.g., at least) from the plug to the first sensor. Still further, the terminal connector may be located within the plug and the first internal cable may extend from the first sensor to the terminal connector. Even further, the external cable may extend outside the container, for example, from the plug.

Moreover, in a number of embodiments, the structural member maintains a substantially consistent first distance between the plug and the first sensor. Further, in various embodiments, the first internal cable conducts a first level signal from the first sensor to the terminal connector, the external cable conducts the first level signal outside the container, or both. Even further, in a number of embodiments, the first internal cable is electrically connected to the terminal connector, the external cable includes a signal connector, for example, configured to electrically connect to the terminal connector, the terminal connector is configured to releasably connect to the signal connector, the terminal connector has at least two electrical connection points with the signal connector, or a combination thereof. Still further, in various embodiments, the terminal connector, the signal connector, or both, are configured to prevent reverse connection of the signal connector to the terminal connector while allowing correct connection of the signal connector to the terminal connector.

Some embodiments further include a second sensor, for example, that detects a second level of the contents in the container. Further, in a number of embodiments, the second level of the contents is different than the first level of the contents. Even further, some embodiments include a second internal cable, for instance, extending from the second sensor to the terminal connector. Still further, in certain embodiments, the second internal cable conducts a second level signal from the second sensor to the terminal connector, the second internal cable is electrically connected to the terminal connector, the terminal connector is configured to conduct the second level signal outside the container to the external cable extending outside the container, the terminal connector has at least three electrical connection points with the signal connector, or a combination thereof. Further still, in particular embodiments, the structural member extends to the second sensor, the structural member maintains a substantially consistent second distance between the plug and the second sensor, the second distance is different than the first distance, or a combination thereof. Even further still, in certain embodiments, the first sensor is positioned near a middle of the container (e.g., in a vertical direction), the second sensor is positioned near a bottom of the container (e.g., in the vertical direction), or both. Moreover, particular embodiments, the terminal connector has at least four electrical connection points with the signal connector.

Various embodiments include a wireless gateway, for example, electrically connected to the external cable, for instance, opposite the signal connector. Further, in some embodiments, the wireless gateway converts the first level signal from the first sensor into a wireless signal, transmits the wireless signal, or both. Still further, in particular embodiments, the wireless gateway converts, transmits, or both, the second level signal, for example, from the second sensor, into the wireless signal. Even further, in certain embodiments, the wireless signal from the wireless gateway includes GPS location data, the wireless signal from the wireless gateway is transmitted to a cloud data processing system, or both. Further still, in some embodiments, the hole is in a top surface of the container, the plug seals the hole, for example, to prevent leakage of the contents from the container through the hole, the hole is threaded, the plug is threaded and screws into the hole, or a combination thereof. Even further still, in a number of embodiments, the plug includes a recess, for example, above the terminal connector, the recess is configured to receive a tool, for instance, to rotate the plug, for example, when the signal connector is disconnected from the terminal connector, or both. Moreover, in some embodiments, the structural member is elongated, the first sensor, the second sensor, the structural member, the first internal cable, and the second internal cable, for example, all fit through the hole (e.g., as an assembly), for instance, connected to the plug, when the apparatus is installed on the container. Furthermore, in various embodiments, the first sensor, the second sensor, or both, are located (e.g., vertically) below the plug, for instance, when the container is sitting on a level surface. For example, in certain embodiments, the structural member includes (e.g., plastic) tubing that is sufficiently flexible to bend, for instance, adjacent to the plug, for example, due to gravity. In some embodiments, this keeps the first sensor and the second sensor (e.g., vertically) below the plug, for example, when the container is sitting on a non-level surface. Even further, in various embodiments, the container is a drum, the hole is a vent hole (e.g., of the drum), or both.

In a number of embodiments, the signal connector includes a first magnet the plug includes a second magnet, or both. Further, in some embodiments, the first magnet and the second magnet are oriented to prevent reverse connection of the signal connector to the terminal connector, for example, while allowing correct connection of the signal connector to the terminal connector. For example, in certain embodiments, the first magnet and the second magnet are oriented such that during correct connection of the signal connector to the terminal connector, a north pole of the first magnet is adjacent to a south pole of the second magnet, a south pole of the first magnet is adjacent to a north pole of the second magnet, or both. Even further, in particular embodiments, during reverse connection of the signal connector to the terminal connector, the north pole of the first magnet is adjacent to the north pole of the second magnet, the south pole of the first magnet is adjacent to the south pole of the second magnet, or both.

Some embodiments include a wireless gateway, for example, electrically connected to the external cable (e.g., opposite the signal connector). Further, in certain embodiments, the wireless gateway converts (e.g., at least) the first level signal from the first sensor into a wireless signal. Still further, in particular embodiments, the wireless gateway transmits the wireless signal. Even further, in some embodiments, the wireless gateway is mounted, for instance, on an exterior surface of the container. Further still, in certain embodiments, the wireless signal from the wireless gateway includes GPS location data. Even further still, some embodiments include a cloud data processing system. For example, in particular embodiments, the wireless signal from the wireless gateway is transmitted to the cloud data processing system.

In various embodiments, the hole is in a top surface of the container. Further, in a number of embodiments, the plug is configured to seal the hole, for example, to prevent leakage of the contents from the container through the hole. Even further, in some embodiments, the hole is threaded, the plug is threaded, or both. For example, in some embodiments, the plug screws into the hole. Still further, in some embodiments, the plug has a recess, for instance, above the terminal connector. Further still, in particular embodiments, the recess is configured to receive a tool, for example, to rotate the plug, for instance, when the signal connector is disconnected from the terminal connector. Even further still, in various embodiments, the structural member is elongated. Moreover, in certain embodiments, the first sensor, the structural member, the first internal cable, or a combination thereof (e.g., all) fit through the hole (e.g., as an assembly), for example, connected to the plug, for instance, when the apparatus is installed on the container. Furthermore, in a number of embodiments, the structural member is configured to bend, for example, adjacent to the plug. In addition, in some embodiments, this bending may be due to gravity and may keep the first sensor vertically below the plug, for instance, when the container is sitting on a non-level surface. For example, in particular embodiments, the structural member includes plastic tubing, for example, that is sufficiently flexible to bend adjacent to the plug due to gravity to keep the first sensor vertically below the plug when the container is sitting on a non-level surface. Further, in some embodiments, the container is a 200-liter steel drum, the hole is a vent hole of the drum, or both.

Another example of a specific embodiment is an apparatus for detecting a level of contents within a container that includes: a plug, a first sensor, a second sensor, a structural member, a first internal cable, a second internal cable, an external cable, a wireless gateway, and a cloud data processing system. In some embodiments, for example, the plug is configured to mount in a hole in the container, the first sensor detects a first level of the contents in the container, the second sensor detects a second level of the contents in the container, or a combination thereof. Further, in various embodiments, the structural member extends from the plug to the first sensor, the second sensor, or both, the first internal cable extends from the first sensor to the plug, the second internal cable extends from the second sensor to the plug, or a combination thereof. Still further, in some embodiments, the external cable extends outside the container, the wireless gateway is electrically connected to the external cable (e.g., opposite the signal connector), or both.

Further, in various embodiments, the second level of the contents is different than the first level of the contents, the structural member maintains a substantially consistent first distance between the plug and the first sensor, the structural member maintains a substantially consistent second distance between the plug and the second sensor, the second distance is different than the first distance, or a combination thereof. Even further, in a number of embodiments, the first internal cable conducts a first level signal from the first sensor to the plug, the second internal cable conducts a second level signal from the second sensor to the plug, the plug includes a terminal connector, the first internal cable is electrically connected to the terminal connector, the second internal cable is electrically connected to the terminal connector, or a combination thereof. Still further, in some embodiments, the terminal connector is configured to releasably connect to the external cable (e.g., that extends outside the container), the external cable conducts the first level signal (e.g., outside the container), the cable conducts the second level signal (e.g., outside the container), the external cable includes a signal connector (e.g., configured to electrically connect to the terminal connector), or a combination thereof. Further still, in various embodiments, the wireless gateway converts (e.g., at least) the first level signal from the first sensor, the second level signal from the second sensor, or both, into a wireless signal, the wireless gateway transmits the wireless signal, the wireless signal from the wireless gateway includes GPS location data, the wireless signal from the wireless gateway is transmitted to the cloud data processing system, or a combination thereof. Even further still, in some embodiments, the hole is in a top surface of the container, the hole is threaded, the plug is threaded, the plug screws into the hole, or a combination thereof.

Moreover, in some embodiments, the plug has a recess, for example, above the terminal connector, the recess is configured to receive a tool to rotate the plug, for instance, when the signal connector is disconnected from the terminal connector, or both. Furthermore, in particular embodiments, the structural member is elongated, the first sensor, the second sensor, the structural member, the first internal cable, the second internal cable, or a combination thereof (e.g., all) fit through the hole (e.g., as an assembly), for instance, connected to the plug, for example, when the apparatus is installed on the container. Still further, in some embodiments, the first sensor is located vertically below the plug, for example, when the container is sitting on a level surface. For instance, in certain embodiments, the structural member includes (e.g., plastic) tubing, for example, that is sufficiently flexible to bend adjacent to the plug due to gravity to keep the first sensor vertically below the plug, for instance, when the container is sitting on a non-level surface. Even further, in some embodiments, the container is a drum, the hole is a vent hole (e.g., of the drum), or both. In addition, various other embodiments of the invention are also described herein, and other benefits of certain embodiments are described herein or may be apparent to a person of skill in this area of technology.

### BRIEF DESCRIPTION OF THE DRAWINGS

FIG. 1 is an isometric view illustrating an example of an apparatus for detecting a level of contents within a container wherein the container is a drum and part of the drum is cut away to better illustrate the apparatus;

FIG. 2 is an isometric view illustrating the apparatus for detecting the level of the contents of FIG. 1 shown with the entire container omitted;

FIG. 3 is an isometric view illustrating part of the apparatus of FIG. 1 including a plug, part of a structural member, and an external cable with a signal connector;

FIG. 4 is an isometric view illustrating the part of the apparatus of FIG. 3 except shown with the external cable and the signal connector omitted to reveal a terminal connector within the plug;

FIG. 5 is an isometric view of the external cable and the signal connector of FIG. 3, shown from a different angle than FIG. 3, and shown with the plug and structural member omitted;

FIG. 6 is a side view illustrating internal components of the signal connector of FIG. 5;

FIG. 7 is a side view illustrating internal components of part of the apparatus of FIG. 1 including the plug, internal components of the plug, the structural member, a first sensor, a first internal cable, and a second internal cable, shown with the external cable and the signal connector omitted;

FIG. 8 is a side view illustrating internal components of the plug of FIG. 7 including the terminal connector; and

FIG. 9 is an isometric view illustrating the external (i.e., external from the container) part of the apparatus for detecting the level of the contents of FIG. 1 shown with the signal connector disconnected from the terminal connector within the plug.

The drawings provided herewith illustrate, among other things, examples of certain aspects of particular embodiments. Other embodiments may differ. Various embodiments may include aspects shown in the drawings, described in the specification (including the claims), known in the art, or a combination thereof, as examples.

### DETAILED DESCRIPTION OF EXAMPLES OF EMBODIMENTS

This patent application describes, among other things, various apparatuses, processes, and systems, for example, for detecting the level of the contents of a container such as a drum. The figures illustrate one example. Further, various embodiments form, or are part of, an apparatus for detecting the level of the contents of a container. Different embodiments include different combinations of specific components or elements. For instance, various embodiments include a plug (e.g., that mounts in a hole in the container) one or more level sensors, a structural member (e.g., extending from the plug at least to the sensor), and at least one internal cable (e.g., extending from the sensor to the plug). Further, certain embodiments include various systems for processing and communicating information concerning the level of contents within containers. Still further, various embodiments include improvements in level detection of contents of containers, for example, including drums.

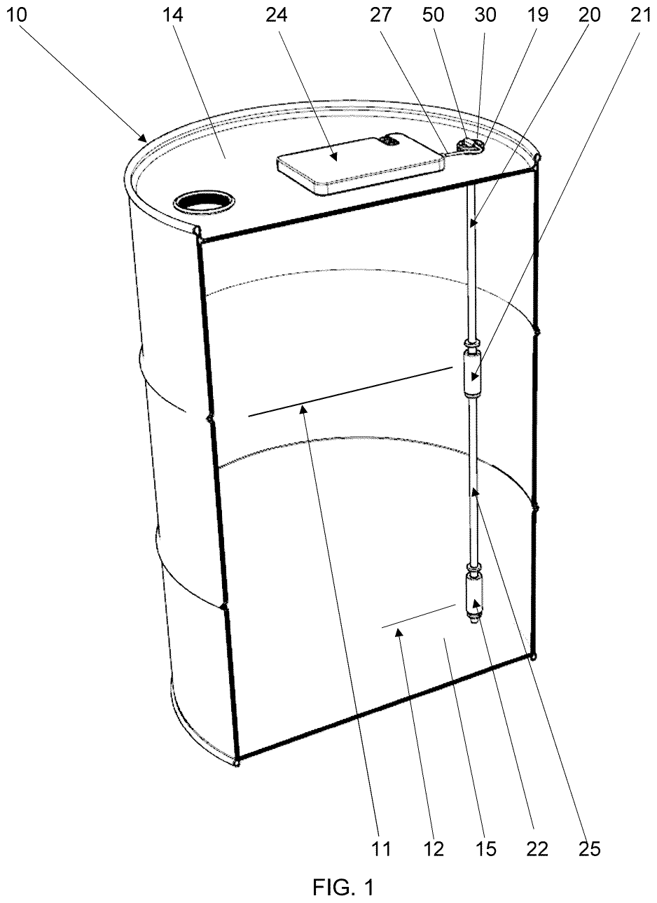

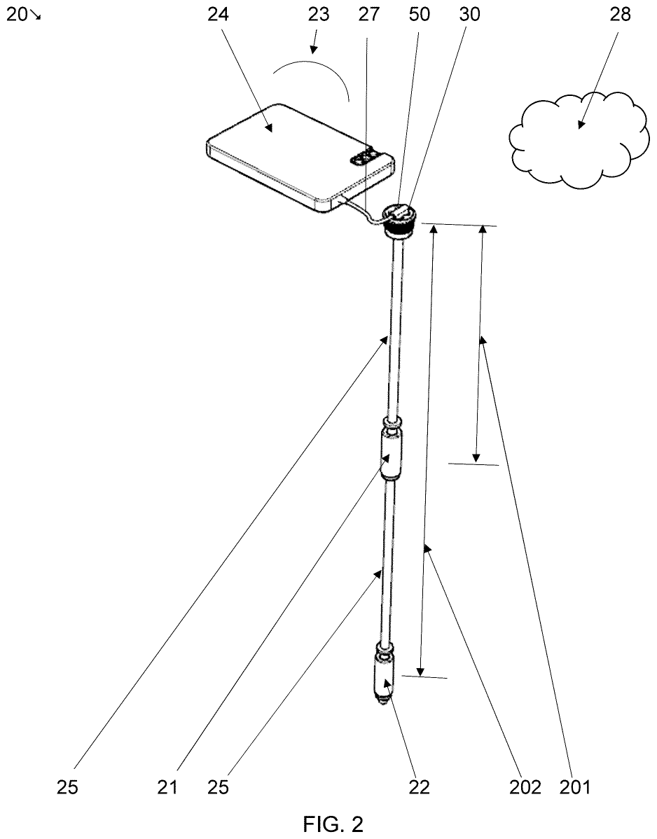

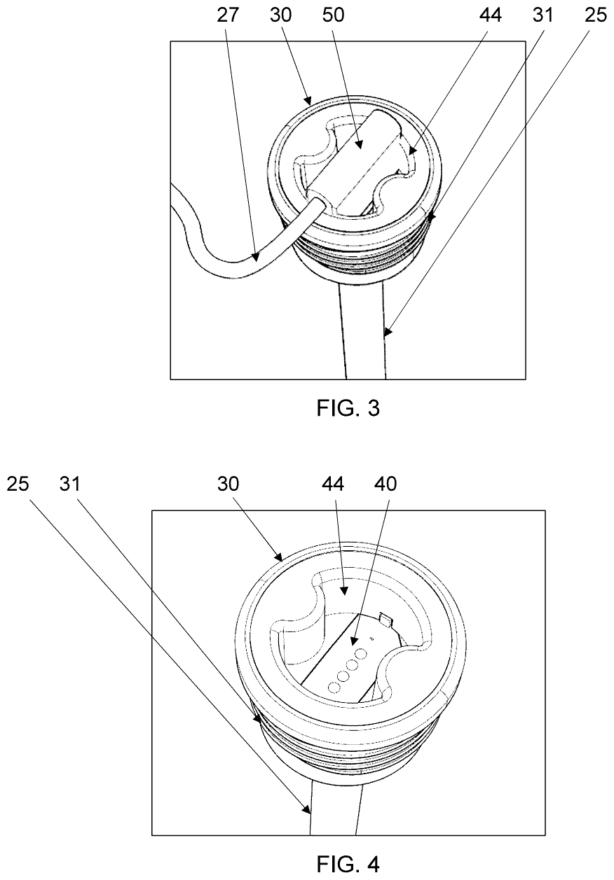

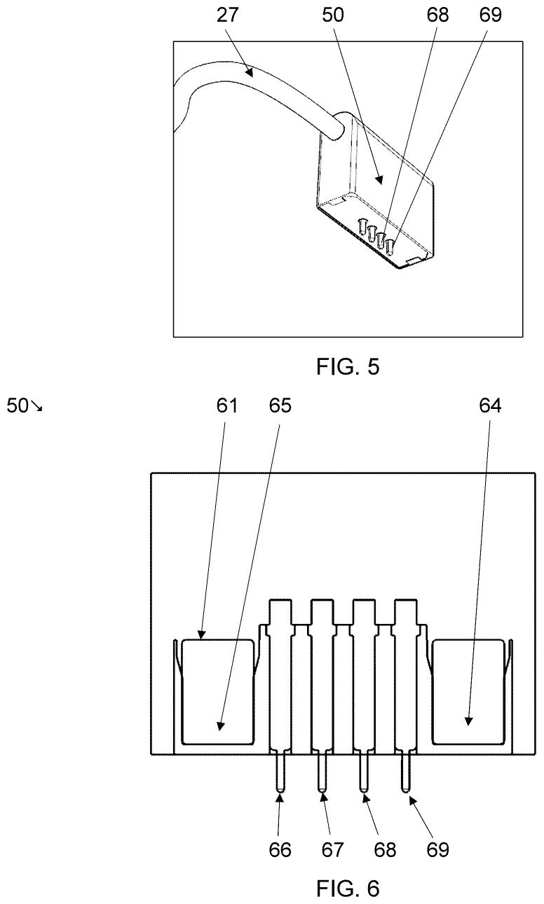

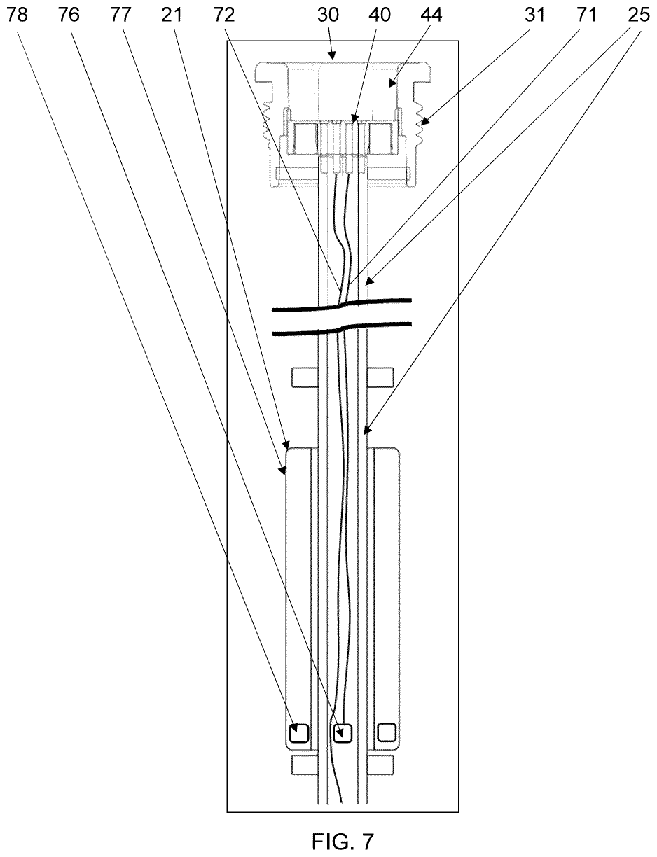

FIG. 2 illustrates, as an example, apparatus 20 for detecting a level of contents within a container. Apparatus 20 is also shown in FIG. 1, along with container 10, which in this example, is a drum, containing contents 15. Contents 15 may be a liquid, for example, and may be or include oil, chemicals, or food, as examples. Container 10 is not shown in FIG. 2 to better illustrate apparatus 20. Further, in FIG. 1, part of drum or container 10 is cut away to better illustrate apparatus 20. In the embodiment shown, container 10 is a circular iron drum and apparatus 20 is an example of a level sensor detection system for the (e.g., liquid) contents of container 10 (e.g., a drum). FIGS. 3-9 each show part of apparatus 20. As shown in FIG. 2. apparatus 20, in the embodiment illustrated, includes plug 30 (shown in more detail in FIGS. 3, 4, and 8), first sensor 21 (shown in more detail in FIG. 7), and structural member 25 shown best in FIGS. 1, 2, and 7). As shown in FIGS. 4, 7, and 8, plug 30 includes terminal connector 40. Further, as shown in FIG. 7, apparatus 20 includes first internal cable 71. Still further, In the embodiment illustrated, first internal cable 71 is located inside structural member 25. Even further, as shown in FIGS. 1, 2, 3, 5, and 9, apparatus 20 includes external cable 27. As identified in FIG. 1, plug 30, in the embodiment shown, is mounted in hole 19 (e.g., a vent hole) in container 10, and plug 30 is configured to mount in hole 19 in container 10 in this embodiment. In various embodiments, the plug (e.g., 30) is configured (e.g., threaded with appropriate threads) to mount in a hole (e.g., 19) in the container (e.g., drum). Still further, referring still to FIG. 1, first sensor 21 detects first level 11 of contents 15 in container 10. First sensor 21 may be a liquid level sensor, for example, and may be made of a soft plastic material, for instance. As shown in FIG. 7, for example, first sensor 21 includes magnetic float 77 and magnet sensor or Hall sensor 76, which detects magnet 78 in float 77 to detect the (e.g., liquid) level height (e.g., level 11). In other embodiments, magnetic switches may be used. First sensor 21, in the embodiment illustrated, is installed inside container 10 (e.g., the circular iron drum shown) and in contact with (e.g., liquid) contents 15. First sensor 21, in the embodiment shown, is capable of accurately detecting the level (e.g., level 11) of contents 15 in container 10. Even further still, when it is necessary to replace apparatus 20 or container 10 (e.g., with another iron drum), due to the soft plastic material used for the sensor (e.g., 21, 22, or both), both storage and installation are very convenient, not prone to breakage, and save space. In other embodiments, the first sensor (e.g., 21) is an ultrasonic, capacitive, or radar sensor, as other examples.

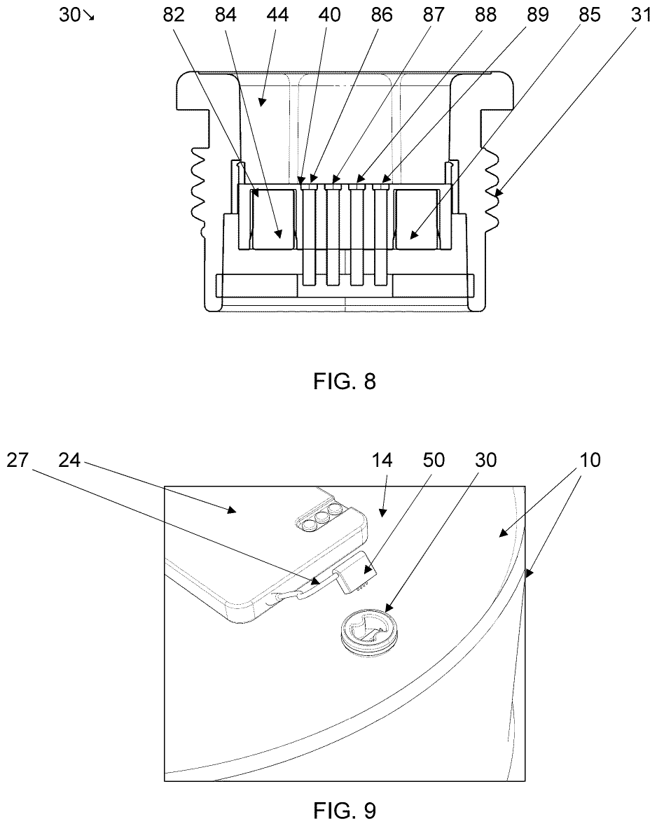

Further, in the embodiment shown, structural member 25 extends (e.g., at least) from plug 30 to first sensor 21. In addition, in the embodiment shown (e.g., in FIGS. 1 and 2), structural member 25 extends further to second sensor 22, which is described further below. Further still, as shown in FIGS. 4, 7, and 8, terminal connector 40 is located, in the embodiment shown, within plug 30. In the embodiment illustrated, terminal connector 40 has four connecting terminals 86, 87, 88, and 89, identified in FIG. 8. After disconnecting signal connector 50 shown best in FIGS. 3, 5, 6, and 9, a tool can be used to remove or install plug 30 within hole 19 in container 10. The tool may be, for example, inserted within recess 44 identified in FIGS. 3, 4, 7, and 8. The tool may be, for example, a standard drum bung wrench or a drum lid installation tool. Even further, terminal connector 40, signal connector 50, or both, may comply with international standard specifications, require no special tools, or both. In the embodiment shown, for example, terminal connector 40 and signal connector 50 are magnetically connected, allowing for easy connection and disconnection. See further description of this magnetic connection below with reference to FIG. 6.

In the embodiment shown, first internal cable 71 shown in FIG. 7 extends from first sensor 21 to terminal connector 40. Further, as shown in FIG. 1, external cable 27 extends outside container 10 from plug 30. Still further, as shown in FIG. 2, structural member 25 maintains substantially consistent first distance 201 between plug 30 and first sensor 21. As used herein, a “substantially consistent” distance, unless indicated otherwise, is a distance that changes by no more than five percent with variations in temperature between zero and 50 degrees C and with variations in the level of the contents (e.g., 15) in the container (e.g., 10), for example. In other embodiments, where a “substantially consistent” distance is mentioned herein, for example, the distance may change by no more than 2, 3, 4, 6, 7, 8, 10, 12, 50, or 20 percent, as other examples, with variations in temperature between zero and 50 degrees C and with variations in the level of the contents (e.g., 15) in the container (e.g., 10). Even further, in the embodiment illustrated, first internal cable 71 (shown in FIG. 7) conducts a first level signal from first sensor 21 to terminal connector 40. In the embodiment shown, the “first level signal” indicates whether first level 11 of contents 15 in container 10 has been reached, for example, as contents 15 in container 10 have been consumed from container 10. Further still, in the embodiment shown, first internal cable 71 is electrically connected to terminal connector 40, for example, to two of the four electrical connection points 66, 67, 68, and 69 shown in FIG. 6 of signal connector 50. Even further still, external cable 27 conducts the first level signal outside of container 10.

Moreover, in the embodiment illustrated, external cable 27 includes signal connector 50, shown in FIGS. 3, 5, 6, and 9, which is configured to electrically connect to terminal connector 40. In the embodiment illustrated, signal connector 50 electrically connects to terminal connector 40. For example, signal connector 50 is shown electrically connected to terminal connector 40 in FIG. 3 and also in FIGS. 1 and 2. In the embodiment illustrated, terminal connector 40 is also configured to releasably connect to signal connector 50. Further, in various embodiments, the terminal connector (e.g., 40) is a multi-pin connector or has at least two electrical connection points with the signal connector. In the embodiment shown, for example, terminal connector 40 has four electrical connection points 66, 67, 68, and 69 with signal connector 50. See, for example, FIG. 6 and also FIGS. 4, 5, and 8. Still further, in various embodiments, the terminal connector (e.g., 40), the signal connector (e.g., 50), or both, are configured to prevent reverse connection of the signal connector to the terminal connector while allowing correct connection of the signal connector to the terminal connector. The embodiment shown is an example. See description of the magnetic connection below with reference to FIG. 6. In other embodiments, the terminal connector, the signal connector, or both, are configured to prevent reverse connection of the signal connector to the terminal connector in another manner while allowing correct connection of the signal connector to the terminal connector. For example, in other embodiments, the electrical connection points and connecting terminals may be spaced or located within the signal connector and terminal connector to prevent reverse connection of the signal connector to the terminal connector while allowing correct connection of the signal connector to the terminal connector. For instance, in certain embodiments, electrical connection points may be unequally spaced within the signal connector and terminal connector or may be located other than in a straight line. In contrast, in the embodiment shown, for example, connecting terminals 86, 87, 88, and 89, identified in FIG. 8, and electrical connection points 66, 67, 68, and 69 shown in FIG. 6, are each evenly spaced and located in a straight line. Further, in other embodiments, the terminal connector, the signal connector, or both, may be configured in another way to prevent reverse connection of the signal connector to the terminal connector while allowing correct connection of the signal connector to the terminal connector. An example is the physical shape of the terminal connector, the signal connector, or both, besides the spacing or location of the electrical connection points and connecting terminals within the signal connector and terminal connector may be selected or configured to prevent reverse connection of the signal connector to the terminal connector while allowing correct connection of the signal connector to the terminal connector.

As mentioned, some embodiments further include a second sensor, for example, that detects a second level of the contents in the container. The embodiment shown is an example. FIGS. 1 and 2 show second sensor 22, for example, that detects second level 12 (shown in FIG. 1) of contents 15 in container 10. As shown in FIG. 1, second level 12 of contents 15 is different than first level 11 of contents 15. Other than location, second sensor 22 may be similar or identical to, or interchangeable with, first sensor 21, as examples. Even further, apparatus 20 includes second internal cable 72 (shown in FIG. 7) extending from second sensor 22 (not shown in FIG. 7 but shown in FIGS. 1 and 2) to terminal connector 40 (shown in FIGS. 4, 7, and 8). In this embodiment, second internal cable 72 conducts a second level signal from second sensor 22 to terminal connector 40. In the embodiment shown, the “second level signal” indicates whether second level 12 of contents 15 in container 10 has been reached, for example, as contents 15 in container 10 have been consumed from container 10. Further, second internal cable 72 is electrically connected to terminal connector 40. Moreover, in the embodiment shown, terminal connector 40 is configured to conduct the second level signal outside container 10 to external cable 27 that extends outside container 10. In addition, in various embodiments, the terminal connector (e.g., 40) has at least three connecting terminals or electrical connection points with the signal connector (e.g., 50). For example, terminal connector 40 has four connecting terminals 86, 87, 88, and 89, that connect with signal connector 50. See, for example, FIG. 8. Moreover, in the embodiment shown, terminal connector 40 has at least four electrical connection points with signal connector 50, for example, as shown in FIGS. 4-6 and 8, for instance, electrical connection points 66, 67, 68, and 69 shown in FIG. 6. Further still, as shown in FIG. 2, in the embodiment shown, structural member 25 extends to second sensor 22. In the embodiment illustrated, structural member 25 maintains substantially consistent second distance 202 (shown in FIG. 2) between plug 30 and second sensor 22. Moreover, in this embodiment, second distance 202 is different than first distance 201. Even further still, referring to FIG. 1, in the embodiment shown, first sensor 21 is positioned near the middle of container 10 (i.e., in the vertical direction), and second sensor 22 is positioned near the bottom of container 10. In the embodiment illustrated, the middle of container 10 is at first level 11 of contents 15 in container 10 shown in FIG. 1 and the bottom of container 10 is at or near second level 12 of contents 15. Further, in this context, unless stated otherwise, “near” means within plus or minus ten percent, for example, of the height of container 10. In other embodiments, where “near” is used herein, the height may be plus or minus 5, 8, 12, 15, 20, or 25 percent, as other examples, of the height of container 10. Further still, although the embodiment shown includes two sensors 21 and 22, other embodiments may have a different number of sensors, for example, 1, 3, 4, 5, 6, 7, 8, 9, 10, 12, or 15 sensors, or more, as examples. In particular embodiments, for example, the apparatus includes a third sensor, for instance, that detects a third level of the contents, for example, where the third level of the contents is different than the first level of the contents and the third level of the contents is different than the second level of the contents.

As shown in FIGS. 1, 2, and 9, apparatus 20 includes wireless gateway 24 that is electrically connected to external cable 27 opposite signal connector 50. For example, external cable 27 may plug into wireless gateway 24. Further, as shown in FIG. 1, wireless gateway 24 is mounted on an exterior surface of container 10. See FIGS. 1 and 9, for example. Specifically, in the embodiment shown, wireless gateway 24 is mounted on top surface 14 of container 10. Wireless gateway 24, in the embodiment shown, is a wireless transmission device that transmits detected (e.g., liquid) level data from the sensor(s) (e.g., 21, 22, or both), for instance, to the cloud (e.g., 28 shown in FIG. 2), via wireless transmission technology. In the embodiment shown, wireless gateway 24 converts the first level signal from first sensor 21 into a wireless signal and transmits the wireless signal (e.g., 23 shown in FIG. 2). Still further, in the embodiment illustrated, wireless gateway 24 converts and transmits the second level signal from second sensor 22, into wireless signal 23. Even further, in the embodiment shown, wireless signal 23 from wireless gateway 24 includes GPS location data, for example, indicating the location of wireless gateway 24. A GPS positioning system, for example, may provide real-time tracking of position information of container 10 (e.g., the circular iron drum). Further, in the embodiment shown, wireless signal 23 from wireless gateway 24 may be transmitted, for example, to a cloud data processing system (e.g., 28). Even further still, some embodiments include the cloud data processing system (e.g., 28). In the embodiment shown, cloud data processing system 28 receives and processes the (e.g., liquid) level data sent from wireless gateway 24, allowing users to access and view the level inside the circular iron drum (e.g., container 10) via a computer. Moreover, in various embodiments, cloud monitoring allows users to view the level of contents 15 and the position information of container 10 (e.g., the iron drum) in real time via a computer or phone. In a number of embodiments, users can access monitoring data anytime, anywhere via a computer or phone, for example.

As shown in FIG. 1, hole 19 in container 10 that plug 30 is installed in is in top surface 14 of container 10. In the embodiment illustrated, plug 30 seals hole 19, for example, to prevent leakage of contents 15 from container 10 through hole 19. In the embodiment shown, hole 19 is threaded. Further, in this embodiment, plug 30 is threaded, for instance, with threads 31 identified in FIGS. 3, 4, 7, and 8. As shown in FIG. 1, in the embodiment illustrated, plug 30 screws into hole 19. Still further, as shown in FIGS. 3, 4, 7, and 8, in the embodiment shown, plug 30 includes recess 44 located above terminal connector 40 (e.g., shown in FIGS. 4, 7, and 8). In the embodiment illustrated, recess 44 is configured to receive a tool, for instance, to rotate plug 30, for example, when signal connector 50 is disconnected from terminal connector 40. The tool can be used, for example, to rotate plug 30, for example, to remove or install plug 30, for instance, along with the other components of apparatus 20 that are located inside container 10. Signal connector 50 is shown connected in FIG. 3 and is omitted (i.e., disconnected from terminal connector 40) in FIG. 4. Signal connector 50 is also shown disconnected from terminal connector 40 in FIG. 9.

As shown in FIGS. 1 and 2, structural member 25 is elongated in the embodiment illustrated. See also FIG. 7. As used herein, “elongated” means one dimension (e.g., length or the vertical dimension when in operation) is at least five times any perpendicular dimension. In various embodiments, an elongated component or assembly may have a length, for example, that is 5, 6, 7, 8, 9, 10, 12, 15, or 20 times any perpendicular dimension of that component or assembly. Further, in the embodiment shown, first sensor 21, second sensor 22, structural member 25, first internal cable 71, and second internal cable 72, all fit through hole 19 (i.e., as an assembly), for instance, connected to plug 30, when apparatus 20 is installed on container 10 or removed therefrom. Still further, in the embodiment shown, first sensor 21 and second sensor 22 are located vertically below plug 30 when container 10 is sitting on a level surface. In this context, “vertically below” means (vertical) to within 10 degrees unless stated otherwise. In various embodiments, for example, one or both sensors may be vertically below the plug to within 2, 5, 10, 15, 20, or 25 degrees, for example, when the container is sitting on a level surface.

Further still, in a number of embodiments, the structural member (e.g., 25) is configured to bend, for example, adjacent to the plug (e.g., 30), for instance, due to gravity. For example, in certain embodiments, the structural member may have a hinge or pivot point, for example, adjacent to the plug. This may keep the first sensor, for example, vertically below the plug when the container is sitting on a non-level surface. As used herein, “adjacent” in this context, means within the top 25 percent of first distance 201 shown in FIG. 2 between plug 30 and first sensor 21. Even further, in the particular embodiment illustrated, structural member 25 includes, or consists of (e.g., plastic) tubing. In addition, in the embodiment illustrated, first internal cable 71 is located inside the tubing of structural member 25. In various embodiments, the structural member (e.g., 25) is non-metallic, for example, plastic. Further, in a number of embodiments, the tubing is sufficiently flexible to bend, for instance, adjacent to plug 30, due to gravity. This is another example of how the structural member may be configured to bend. See FIG. 7 and also FIGS. 1 and 2. Gravity may pull, for example, on sensors 21 and 22, on structural member 25, or both. In some embodiments, this keeps first sensor 21 and second sensor 22 vertically below plug 30 (e.g., even) when container 10 is sitting on a non-level surface. In the embodiment shown, even if container 10 is placed on uneven ground, for example, the sensor (e.g., 21, 22, or both) can remain vertical without affecting sensor function. Further still, in the embodiment illustrated (e.g., in FIG. 1) container 10 is a (e.g., circular iron) drum, for example, a 200-liter steel drum, and hole 19 is a vent hole of the drum. An international standard for the lid of a 200-liter drum (also known as a 55-gallon drum) is ISO 15750. This standard specifies the design, manufacturing, and dimensional requirements for steel drums, which are widely used for transporting and storing liquid products such as oil, chemicals, and food. In a number of embodiments, for example, container 10 may comply with this standard. Various drum lids include two holes that are plugged with different types or sizes of fittings. Various drums, for example, have a 2-inch threaded fitting (e.g., a 2-inch NPT or BSP bung). This is a large-diameter threaded fitting mainly used for filling and discharging contents (e.g., liquids) into or out of the drum. Further, various drums have a ¾-inch threaded fitting (e.g., ¾-inch NPT or BSP bung). This smaller hole or fitting is typically used for venting or other smaller connections. Hole 19 may be this smaller vent hole or fitting, for example. Still further, these fittings may comply with internationally recognized thread standards (NPT or BSP), making them compatible with equipment and tools found in different regions.

As shown in FIG. 6, in the embodiment illustrated, signal connector 50 includes first magnet 61. Further, as shown in FIG. 8, plug 30 or terminal connector 40, in the embodiment shown, includes second magnet 82. Further still, in the embodiment shown, first magnet 61 and second magnet 82 are oriented to prevent reverse connection of signal connector 50 to terminal connector 40, while allowing correct connection of signal connector 50 to terminal connector 40. Correct connection of signal connector 50 to terminal connector 40, in the embodiment illustrated, is shown, for example, in FIGS. 1-3. Reverse connection of signal connector 50 to terminal connector 40 would occur if signal connector 50 were rotated 180 degrees relative to terminal connector 40 from what is shown. Even further, in the embodiment illustrated, first magnet 61 and second magnet 82 are oriented such that during correct connection of signal connector 50 to terminal connector 40, north pole 64 of first magnet 61 is adjacent to south pole 85 of second magnet 82, and south pole 65 of first magnet 61 is adjacent to north pole 84 of second magnet 82. See FIGS. 6 and 8, for example. Even further still, in the embodiment shown, during reverse connection of signal connector 50 to terminal connector 40 (i.e., if FIG. 6 were reversed from what is shown), north pole 64 of first magnet 61 would be adjacent to north pole 84 of second magnet 82 and south pole 65 of first magnet 61 would be adjacent to south pole 85 of second magnet 82. In the embodiment illustrated, adjacent magnetic poles of the same polarity cause the magnets to repulse each other, which prevents reverse connection of signal connector 50 to terminal connector 40.

Other embodiments include an apparatus or method of obtaining or providing an apparatus or information, for instance, that include a novel combination of the features described herein. Even further embodiments include at least one means for accomplishing at least one functional aspect described herein. The subject matter described herein includes various means for accomplishing the various functions or acts described herein or that are apparent from the structure and acts described. Each function described herein is also contemplated as a means for accomplishing that function, or where appropriate, as a step for accomplishing that function. Moreover, various embodiments include certain (e.g., combinations of) aspects described herein. All novel combinations are potential embodiments. Some embodiments may include a subset of elements described herein and various embodiments include additional elements as well.

Further, various embodiments of the subject matter described herein include various combinations of the acts, structure, components, and features described herein, shown in the drawings, or that are known in the art. Moreover, certain procedures can include acts such as manufacturing, obtaining, or providing components that perform functions described herein or in the documents that are incorporated by reference. Further, as used herein, the word “or”, except where indicated otherwise, does not imply that the alternatives listed are mutually exclusive. Even further, where alternatives are listed herein, it should be understood that in some embodiments, fewer alternatives may be available, or in particular embodiments, just one alternative may be available, as examples.

What is claimed is:

1. An apparatus for detecting a level of contents within a container, the apparatus comprising:
a plug configured to mount in a hole in the container;
a first sensor that detects a first level of the contents in the container;
a structural member extending at least from the plug to the first sensor;
a terminal connector within the plug;
a first internal cable extending from the first sensor to the terminal connector; and
an external cable extending outside the container from the plug;
wherein:
the structural member maintains a substantially consistent first distance between the plug and the first sensor;
the first internal cable conducts a first level signal from the first sensor to the terminal connector;
the external cable conducts the first level signal outside the container;
the first internal cable is electrically connected to the terminal connector;
the external cable comprises a signal connector configured to electrically connect to the terminal connector;
the terminal connector is configured to releasably connect to the signal connector;
the terminal connector has at least two electrical connection points with the signal connector; and
the terminal connector and the signal connector are configured to prevent reverse connection of the signal connector to the terminal connector while allowing correct connection of the signal connector to the terminal connector.

2. The apparatus of claim 1 further comprising:
a second sensor that detects a second level of the contents in the container wherein the second level of the contents is different than the first level of the contents; and
at least a second internal cable extending from the second sensor to the terminal connector;
wherein:
the second internal cable conducts a second level signal from the second sensor to the terminal connector;
the second internal cable is electrically connected to the terminal connector;
the terminal connector is configured to conduct the second level signal outside the container to the external cable extending outside the container;
the terminal connector has at least three electrical connection points with the signal connector;
the structural member extends to the second sensor;
the structural member maintains a substantially consistent second distance between the plug and the second sensor; and
the second distance is different than the first distance.

3. The apparatus of claim 2 wherein:
the first sensor is positioned near a middle of the container in a vertical direction; and
the second sensor is positioned near a bottom of the container in the vertical direction.

4. The apparatus of claim 2 wherein the terminal connector has at least four electrical connection points with the signal connector.

5. The apparatus of claim 2 further comprising a wireless gateway electrically connected to the external cable opposite the signal connector; wherein:
the wireless gateway converts the first level signal from the first sensor into a wireless signal and transmits the wireless signal;
the wireless gateway converts and transmits the second level signal from the second sensor into the wireless signal;
the wireless signal from the wireless gateway further includes GPS location data;
the wireless signal from the wireless gateway is transmitted to a cloud data processing system;
the hole is in a top surface of the container;
the plug seals the hole to prevent leakage of the contents from the container through the hole;
the hole is threaded;
the plug is threaded and screws into the hole;
the plug comprises a recess above the terminal connector;
the recess is configured to receive a tool to rotate the plug when the signal connector is disconnected from the terminal connector;
the structural member is elongated;
the first sensor, the second sensor, the structural member, the first internal cable, and the second internal cable all fit through the hole as an assembly connected to the plug when the apparatus is installed on the container;
the first sensor and the second sensor are located vertically below the plug when the container is sitting on a level surface;
the structural member comprises plastic tubing that is sufficiently flexible to bend adjacent to the plug due to gravity to keep the first sensor and the second sensor vertically below the plug when the container is sitting on a non-level surface;
the container is a drum; and
the hole is a vent hole of the drum.

6. The apparatus of claim 1 wherein:
the signal connector comprises a first magnet;
the plug comprises a second magnet;
the first magnet and the second magnet are oriented to prevent reverse connection of the signal connector to the terminal connector while allowing correct connection of the signal connector to the terminal connector.

7. The apparatus of claim 6 wherein the first magnet and the second magnet are oriented such that:
during correct connection of the signal connector to the terminal connector: a north pole of the first magnet is adjacent to a south pole of the second magnet; and a south pole of the first magnet is adjacent to a north pole of the second magnet; and
during reverse connection of the signal connector to the terminal connector: the north pole of the first magnet is adjacent to the north pole of the second magnet; and the south pole of the first magnet is adjacent to the south pole of the second magnet.

8. The apparatus of claim 1 further comprising a wireless gateway electrically connected to the external cable opposite the signal connector, wherein the wireless gateway converts at least the first level signal from the first sensor into a wireless signal and the wireless gateway transmits the wireless signal.

9. The apparatus of claim 8 wherein:
the wireless gateway is mounted on an exterior surface of the container; and
the wireless signal from the wireless gateway further includes GPS location data.

10. The apparatus of claim 9 further comprising a cloud data processing system wherein the wireless signal from the wireless gateway is transmitted to the cloud data processing system.

11. The apparatus of claim 1 wherein the hole is in a top surface of the container.

12. The apparatus of claim 1 wherein the plug is configured to seal the hole to prevent leakage of the contents from the container through the hole.

13. The apparatus of claim 1 wherein: the hole is threaded; the plug is threaded; and the plug screws into the hole.

14. The apparatus of claim 1 wherein: the plug comprises a recess above the terminal connector; and the recess is configured to receive a tool to rotate the plug when the signal connector is disconnected from the terminal connector.

15. The apparatus of claim 1 wherein the structural member is elongated.

16. The apparatus of claim 1 wherein the first sensor, the structural member, and the first internal cable all fit through the hole as an assembly connected to the plug when the apparatus is installed on the container.

17. The apparatus of claim 1 wherein the structural member is configured to bend adjacent to the plug due to gravity to keep the first sensor vertically below the plug when the container is sitting on a non-level surface.

18. The apparatus of claim 1 wherein the structural member comprises plastic tubing that is sufficiently flexible to bend adjacent to the plug due to gravity to keep the first sensor vertically below the plug when the container is sitting on a non-level surface.

19. The apparatus of claim 1 wherein the container is a 200-liter steel drum and the hole is a vent hole of the drum.

20. An apparatus for detecting a level of contents within a container, the apparatus comprising:
a plug configured to mount in a hole in the container;
a first sensor that detects a first level of the contents in the container;
a second sensor that detects a second level of the contents in the container;
a structural member extending from the plug to the first sensor and to the second sensor;
at least a first internal cable extending from the first sensor to the plug;
at least a second internal cable extending from the second sensor to the plug;
an external cable extending outside the container;
a wireless gateway electrically connected to the external cable opposite the signal connector; and
a cloud data processing system;
wherein:
the second level of the contents is different than the first level of the contents;
the structural member maintains a substantially consistent first distance between the plug and the first sensor;
the structural member maintains a substantially consistent second distance between the plug and the second sensor;
the second distance is different than the first distance;
the first internal cable conducts a first level signal from the first sensor to the plug;
the second internal cable conducts a second level signal from the second sensor to the plug;
the plug comprises a terminal connector;
the first internal cable is electrically connected to the terminal connector;
the second internal cable is electrically connected to the terminal connector;
the terminal connector is configured to releasably connect to the external cable extending outside the container;
the external cable conducts the first level signal outside the container;
the external cable conducts the second level signal outside the container;
the external cable comprises a signal connector configured to electrically connect to the terminal connector;
the wireless gateway converts at least the first level signal from the first sensor and the second level signal from the second sensor into a wireless signal;
the wireless gateway transmits the wireless signal;
the wireless signal from the wireless gateway includes GPS location data;
the wireless signal from the wireless gateway is transmitted to the cloud data processing system;
the hole is in a top surface of the container;
the hole is threaded;
the plug is threaded and screws into the hole;
the plug comprises a recess above the terminal connector;
the recess is configured to receive a tool to rotate the plug when the signal connector is disconnected from the terminal connector;
the structural member is elongated;
the first sensor, the second sensor, the structural member, the first internal cable, and the second internal cable all fit through the hole as an assembly connected to the plug when the apparatus is installed on the container;
the first sensor is located vertically below the plug when the container is sitting on a level surface;
the structural member comprises plastic tubing that is sufficiently flexible to bend adjacent to the plug due to gravity to keep the first sensor vertically below the plug when the container is sitting on a non-level surface;
the container is a drum; and
the hole is a vent hole of the drum.
